(19) United States
(12) Patent Application Publication
(10) Pub. No.: US 2026/0149956 A1
(43) Pub. Date: May 28, 2026

(54) SERVICE DISCOVERY AND MANAGEMENT IN A NETWORK

(71) Applicant: Rakuten Mobile, Inc., Tokyo (JP)

(72) Inventors: Saurabh VERMA, Tokyo (JP); Masahiko Nanri, Tokyo (JP)

(73) Assignee: Rakuten Mobile, Inc., Tokyo (JP)

(21) Appl. No.: 18/960,444

(22) Filed: Nov. 26, 2024

(51) Int. Cl. H04W 4/50; H04L 67/51

(52) U.S. Cl. CPC H04W 4/50; H04L 67/51

(57) ABSTRACT

Provided are apparatus, method, and device for automatically and dynamically discover and manage services in a private network. According to example embodiments, the apparatus may be configured to: receive, from a user equipment within a private network, a service request to receive a service over the private network; obtain information associated with the service; and determine a service delivery point from which the service is delivered to the user equipment based on the obtained information; wherein the apparatus may be deployed on an on-premise mobile edge cloud (MEC) that is deployed at a same location as the private network.

### FIELD

The present disclosure relate to discovery and management of services in a telecommunication network.

### BACKGROUND

The information disclosed in this background section is only for enhancement of understanding of the general background of the disclosure and should not be taken as an acknowledgement or any form of suggestion that this information forms the prior art already known to a person skilled in the art.

5G technologies have emerged as an important component in a telecommunications system, as it connects end-user devices (or user equipment) to other parts of the network. One aspect of the 5G technologies involves deployment and usage of private 5G networks. Such private 5G networks may be utilized and deployed at specific locations to provide specific services, such as 5G private networks for a school, factory, hospital, and the like.

### SUMMARY

Example embodiments of the present disclosure automatically and dynamically discover and manage services in a private network. As such, example embodiments of the present disclosure allow for efficient and effective discovery and management of services without relying on the computational resources of the user equipment and devices in the private network, thereby providing a simple and effective deployment architecture for private networks at various locations

According to example embodiments, an apparatus is provided. The apparatus may be configured to: receive, from a user equipment within a private network, a service request to receive a service over the private network; obtain information associated with the service; and determine a service delivery point from which the service may be delivered to the user equipment based on the obtained information; wherein the apparatus may be deployed on an on-premise mobile edge cloud (MEC) that is deployed at a same location as the private network.

According to example embodiments, a method is provided. The method may include: receiving, from a user equipment within a private network, a service request to receive a service over the private network; obtaining information associated with the service; and determining a service delivery point from which the service may be delivered to the user equipment based on the obtained information; wherein the method may be performed by an apparatus that is deployed on an on-premise mobile edge cloud (MEC) that is deployed at a same location as the private network.

According to example embodiments, a non-transitory computer-readable recording medium is provided. The non-transitory computer-readable recording medium may have recorded thereon instructions executable by an apparatus to cause the apparatus to perform a method including: receiving, from a user equipment within a private network, a service request to receive a service over the private network; obtaining information associated with the service; and determining a service delivery point from which the service may be delivered to the user equipment based on the obtained information; wherein the apparatus may be deployed on an on-premise mobile edge cloud (MEC) that is deployed at a same location as the private network.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example private 5G network deployment architecture in the related art;

FIG. 2 illustrates an example system architecture, according to one or more example embodiments;

FIG. 3 illustrates a flow diagram of an example method for discovering and managing services, according to one or more embodiments;

FIG. 4 illustrates a flow sequence of an example use case for discovery and management of services, according to one or more embodiments; and

FIG. 5 illustrates a diagram of example components of a device for implementing one or more example embodiments.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

The foregoing disclosure provides illustration and description but is not intended to be exhaustive or to limit the implementations to the precise form disclosed. Modifications and variations are possible in light of the above disclosure or may be acquired from practice of the implementations.

Further, although some embodiments of the present disclosure may be described herein with reference to the 5G system/network or to specific components of the 5G system/network, it can be understood that the scope of the present disclosure should not be limited thereto. Specifically, example embodiments of the present disclosure may also apply to any suitable network elements in any suitable telecommunication system, such as a 4G LTE system, a 6G system, and the like, without departing from the scope of the present disclosure.

In order for a private 5G network to obtain and provide the services to users in the networks, the private 5G network is communicatively coupled to a mobile edge cloud (MEC) provider(s) and/or hyperscaler(s), which provide data and services to the private 5G network via an MEC deployed on the premise of the respective private 5G networks. For example, an MEC provider may provide data and services to a private 5G network deployed at a hospital in a specific location via an MEC deployed at the same specific location.

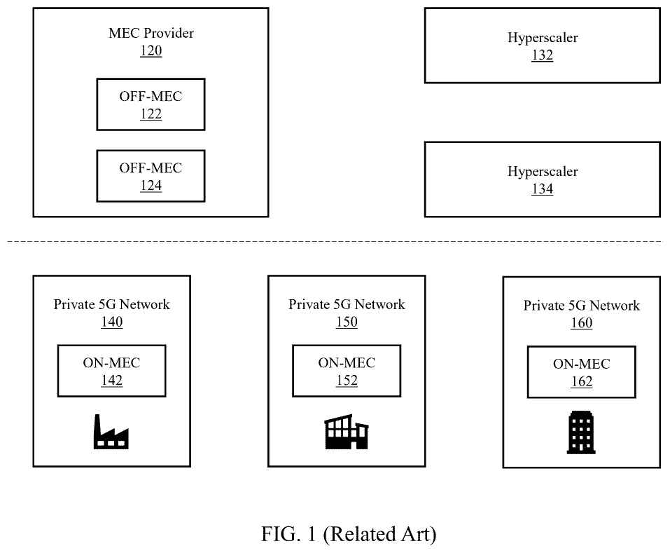

FIG. 1 illustrates an example private 5G network deployment architecture in the related art. As shown in FIG. 1, the private 5G network deployment architecture may involve at least an MEC provider 120, a plurality of off-premise (OFF) MECs 122,124, a plurality of hyperscalers 132,134, a plurality of private 5G networks 140,150,160, and a plurality of on-premise (ON) MECs 142,152,162. The side involving the MEC provider 120, the plurality of off-premise (OFF) MECs 122,124, and the plurality of hyperscalers 132,134 may be referred to as service deployment horizon, while the side involving the plurality of private 5G networks 140,150,160 and the plurality of on-premise (ON) MECs 142,152,162 may be referred to as private 5G networks horizon.

The private 5G network 140 may be deployed at a factory and include the ON-MEC 142 deployed at the factory, the private 5G network 150 may be deployed at a school and include the ON-MEC 152 deployed at the school, and the private 5G network 160 may be deployed at a hospital and include the ON-MEC 162 deployed at the hospital. Each of the plurality of ON-MECs 142,152,162 may be communicatively coupled to one or more of the plurality of OFF-MECs 122,124 of the MEC provider 120 and the plurality of hyperscalers 132,134 in order to receive data and services.

Here, it is understood that a private 5G network may be deployed with a specific purpose along with a specific network capacity, requirements, objectives, and the like associated with such purpose. For example, the private 5G network 160 (which is deployed at a hospital) may be deployed with a purpose related to management and operations of medical devices/equipment, and may have a specific network capacity, requirements, objectives, and the like associated with such management and operations.

Further, the services may be provided from the MEC provider 120 and/or the plurality of hyperscalers 132,134 to a user equipment (not shown) in the plurality of private 5G networks 140,150,160. The user equipment may be designed to serve a specific purpose associated a specific private 5G network. For example, a user equipment in the private 5G network 160 (which is deployed at a hospital) may include a heart rate monitor (i.e., medical equipment). Similarly, the service provided to such user equipment may include any kind of services, applications (e.g., enterprise applications, industries specific applications, and the like), programs, and the like associated with the purpose of the user equipment.

In this regard, the process for a private 5G network to receive data and services involves searching and identifying a service delivery point. The service delivery point may refer to a node from which data and service(s) are delivered to the user equipment in the private 5G network, and may include the on-premise MEC, the off-premise MECs, and the hyperscalers. It is understood that different service delivery points may be more appropriate and efficient for delivering different kinds of data and services for private 5G networks at different locations.

For example, a medical equipment in the private 5G network 160 (which is deployed at a hospital in a certain location) may need to receive services related to its functions, where such services may be most appropriately provided from the ON-MEC 162 (service point) due to latency requirements.

It is understood that the configuration illustrated in FIG. 1 is simplified for descriptive purpose, and is not intended to limit the scope of the present disclosure in any way. For example, the number of the OFF-MECs, the number of the private 5G networks, the number of the ON-MECs, and the number of the hyperscalers can be any number.

Here, in the related art, the search and identification of the service delivery point is performed by the user equipment within the private 5G network that is requesting the service. However, such configuration puts a significant computational burden on the user equipment. Since the user equipment deployed in the private 5G network is designed to serve a specific purpose, they may not necessarily have a large amount of available computational resources.

As such, there is a need to off load computational burden for searching and identifying a service point for delivering services to the user equipment from the user equipment itself, while ensuring that the identified service delivery point is appropriate for delivering such services.

Accordingly, system, methods, devices, and the like, provided in the example embodiments of the present disclosure automatically and dynamically discover and manage services in a private network.

According to example embodiments, an apparatus deployed on an on-premise mobile edge cloud (MEC) that is deployed at a location of a private network may receive a service request to receive a service from a user equipment within the private network. Subsequently, the apparatus may obtain information associated with the service and determine a service delivery point for delivering the service based on the obtained information.

Ultimately, example embodiments of the present disclosure automatically and dynamically discover and manage services in a private network, which allow for efficient and effective discovery and management of services without relying on the computational resources of the user equipment and devices in the private network.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system of the present disclosure, according to one or more embodiments, are provided in the following.

### Example System Architecture

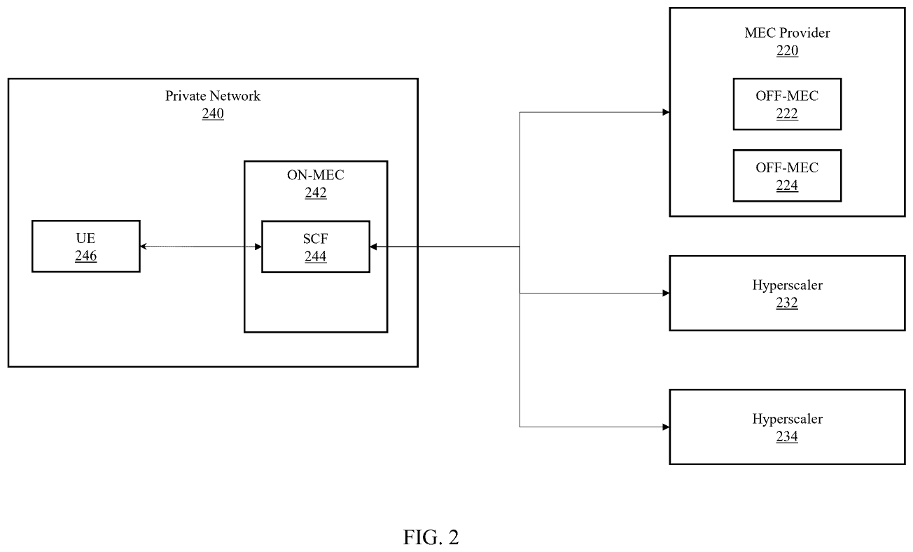

FIG. 2 illustrates an example system architecture, according to one or more example embodiments. As illustrated in FIG. 2, the system architecture may include at least an MEC provider 220, a plurality of off-premise (OFF) MECs 222,224, a plurality of hyperscalers 232,234, a private network 240, an on-premise (ON) MEC 242, a service coordination function (SCF) 244, and a user equipment (UE) 246.

It is contemplated that the system architecture may include more/fewer components than illustrated, and/or may be configured in a different manner, without departing from the scope of the present disclosure. For instance, the system architecture may include any number of the off-premise MECs, the on-premise MECs, and the hyperscalers. Further, in some implementations, the system architecture may include a 5G core, a user plane function (UPF), and the like that facilitate communication within the private network for the UE 246 and the on-premise MEC 242.

The private network 240 may refer to any kind of network that is deployed for private use (i.e., for use/access by specific users/UEs) for a specific purpose at a specific location. Further, the private network 240 may have a specific network capacity, requirements, objectives, and the like associated with such purpose. For example, the private network 240 may be deployed at a hospital with a purpose related to management and operations of medical devices/equipment, and may have a specific network capacity, requirements, objectives, and the like associated with such management and operations. According to example embodiments, the private network 240 may include a private 5G network (i.e., a private network utilizing 5G technologies).

Further, the private network 240 may include the UE 246, the on-premise MEC 242, and the SCF 244.

The UE 246 may include any kind of system, device, equipment, and the like that is connected to the private network 240. The UE 246 may also be communicatively coupled to the on-premise MEC 242 (as well as the SCF 244) within the private network 240, and may request and receive services from the MEC provider 220 and/or the hypervisor 232,234 via the on-premise MEC 242. The services requested by the UE 246 may include any kind of services associated with the operations and functions of the UE 246. For example, the UE 246 may include a heart rate monitor, and may request and receive services associated with the monitoring and reporting of the heart rate of the patient to a monitoring/administration system.

The on-premise MEC 242 may include any kind of mobile edge cloud (MEC), and may be deployed on the premise (at the same location) as the private network 240.

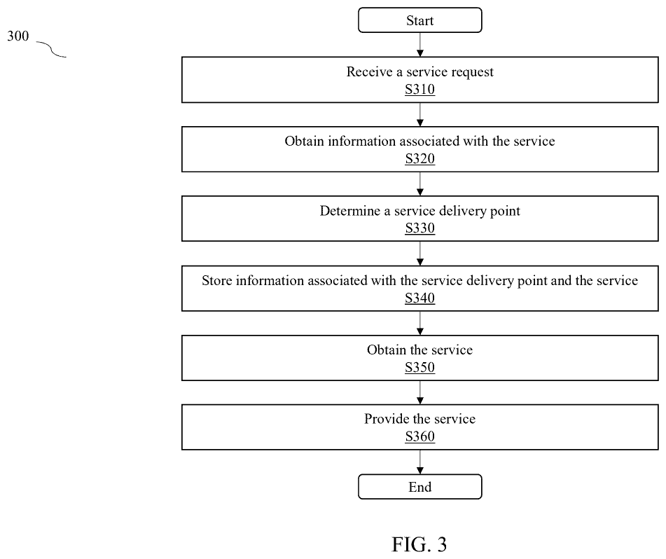

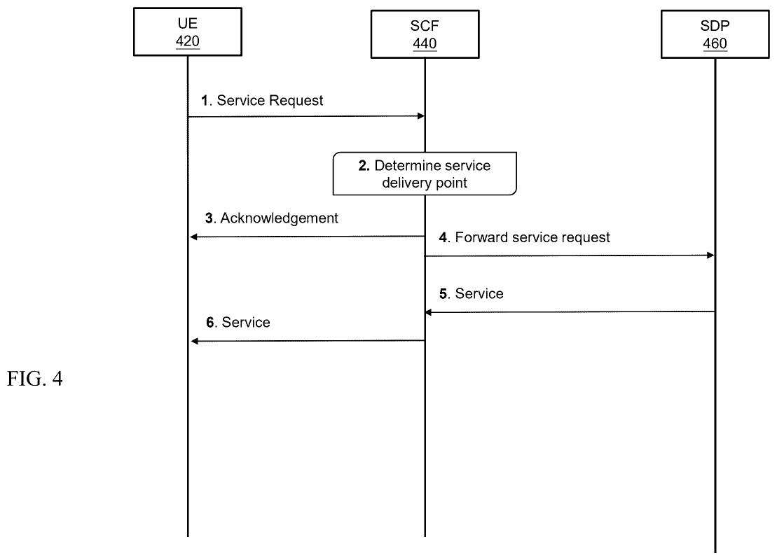

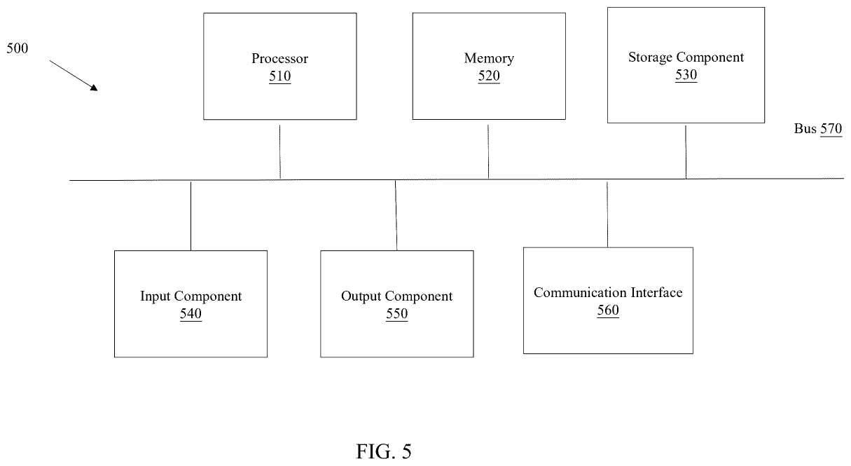

The SCF 244 may include an apparatus, a system, a platform, a module, a network function, or the like, which may be configured to perform one or more operations or actions for discovery and management of services in a network. For example, the SCF 244 may include a network function that is deployed on the on-premise MEC 242. In another example, the SCF 244 may be a subsystem that is deployed with and is communicatively coupled to the on-premise MEC 242. Example operations performable by the SCF 244 for discovery and management of services are described below with reference to FIG. 3 to FIG. 4. Further, several example components which may be included in the SCF 244, according to one or more embodiments, are described below with reference to FIG. 5.

The MEC provider 220 may include a service provider associated with the on-premise MEC 242 and the off-premise MECs 222,224.

The off-premise MECs 222,224 may be similar to the on-premise MEC 242 but are deployed at a location different from the private network 240. The off-premise MECs 222,224 may also be deployed at a different location from each other.

The hyperscalers 232,234 may include service providers different from the MEC provider 220.

Here, it is understood that the private network 240, the on-premise MEC 242, the SCF 244, and the UE 246 may be in the same location, while the MEC provider 220, the off-premise MECs 222,224, and the hyperscalers 232,234 may each be in a location different from the location of the private network 240, the on-premise 242, the SCF 244, and the UE 246.

Further, the on-premise MEC 242, the off-premise MECs 222,224, and the hyperscalers 232,234 may act as a service delivery point for delivering services to the UE 246 (i.e., service delivery point from which the service is delivered to the UE 246).

### Example Operations for Discovering and Managing Services

In the following, several example operations are performable by the apparatus of one or more example embodiments of the present disclosure are described with reference to FIG. 3 to FIG. 4.

FIG. 3 illustrates a flow diagram of an example method 300 for discovering and managing services, according to one or more embodiments. One or more operations in method 300 may be performed by the apparatus of one or more example embodiments of the present disclosure. The apparatus may be configured to discover and manage services.

According to example embodiments, the apparatus may correspond to the SCF 244.

According to example embodiments, the apparatus may be deployed on an on-premise mobile edge cloud (MEC) which is deployed at a same location as a private network. According to example embodiments, the private network may include a private 5G network.

As illustrated in FIG. 3, at operation S310, the apparatus may be configured to receive a service request. The service request may include a request to receive a service, and may be received from a user equipment (UE) that is within and connected to the private network. The service may include a service received over the private network. The method then proceeds to operation S320.

At operation S320, the apparatus may be configured to obtain information associated with the service. The information may include any kind of information associated with the service, such as the type of the service, the requirements associated with the service, the availability of the service, and the like. Further, the apparatus may obtain the information using any means. For example, the apparatus may communicate with an MEC provider to request and obtain the information. In another example, the apparatus may determine the information using artificial intelligence/machine learning. The method then proceeds to operation S330.

At operation S330, the apparatus may be configured to determine a service delivery point for delivering the service based on the obtained information. The service delivery point may refer to a node from which the service may be delivered to the user equipment, and may be determined based on the obtained information.

According to example embodiments, the apparatus may be configured to determine the service delivery by selecting at least one service delivery point from a plurality of service delivery points based on the obtained information. The plurality of service delivery points may include the on-premise MEC, a plurality of off-premise MECs associated with an MEC provider, and a plurality of hyperscalers.

Here, the present disclosure is not limited to how the apparatus may select the at least one service delivery point from the plurality of service delivery points based on the obtained information. For example, the apparatus may select the at least one service delivery point from the plurality of service delivery points which allows for the most efficient delivery of the service to the UE based on the obtained information (e.g., based the requirements of the service including low latency requirements, the on-premise MEC may allow for the most efficient delivery of the service to the UE). In another example, the apparatus may select the at least one service delivery point from the plurality of service delivery points based on the obtained information using an AI/ML model. In further another example, the selection may involve communication with a data server (DNS server, private server, public server, and the like) deployed in the private network (i.e., service discovery based on DNS, and the like).

According to example embodiments, the apparatus may perform additional operations associated with service discovery, such as edge discovery and the like. The method then proceeds to operation S340.

At operation S340, the apparatus may be configured to store information associated with the determined service delivery point and the service. The information associated with the determined service delivery point and the service may include the relationship and correspondence between the service and the determined service delivery point. For example, the apparatus may determine that the on-premise MEC should be the service delivery point for delivering a first service, and determine that an off-premise MEC should be the service delivery point for delivering a second service different from the first service. Accordingly, the apparatus may store information related to the correspondence between the on-premise MEC and the first service, and the off-premise MEC and the second service, such that when the apparatus obtains and provides the services (see below with relation to operations S350 and S360), the apparatus may recognize that the first service should be obtained and provided from the on-premise MEC and the second service should be obtained and provided from the off-premise MEC.

According to example embodiments, the apparatus may be configured to store information associated with the determined service delivery point and the service in a database. The database may be a local database (e.g., database deployed at the same location as the private network), or an external database (e.g., database deployed at a location different from the private network). Accordingly, the computational and resource burden for storing the above information may be off-loaded from the UE.

It is understood that the information associated with the determined service delivery point and the service may include any other information, such as the address of the determined service delivery point, the type of the determined service delivery point, the type of the service, and the like.

It is also understood that the apparatus may act as a forward proxy during operations S310 to S340, where the apparatus operates on behalf of the client (UE) and provide the functionality of service discovery to the private network. As such, the computational burden for performing the service discovery may be off-loaded from the UE. The method then proceeds to operation S350.

At operation S350, the apparatus may be configured to obtain the service from the determined service delivery point. According to example embodiments, the apparatus may be configured to obtain the service by transmitting a request to receive the service to the determined service delivery point, and receiving the service from the determined service delivery point. The method then proceeds to operation S360.

At operation S360, the apparatus may be configured to provide the service to the UE.

According to example embodiments, the apparatus may be configured to provide the service to the UE by performing load balancing. In particular, for example, the apparatus may be configured to determine at least two service delivery points from which the service is delivered to the user equipment based on the obtained information during operation S330, and may obtain the service from the determined at least two service delivery points during operation S350. Accordingly, the apparatus may be configured to perform load balancing between the determined at least two service delivery points when providing the service to the UE.

According to example embodiments, the apparatus may be configured to perform additional operations associated with the provisioning of the service and load balancing, such as caching, service gateway (GW) management and control, data path control, service management, service assurance, and the like.

It is understood that the apparatus may act as a reverse proxy during operations S350 to S360, where the apparatus operates on behalf of the MEC provider/hyperscalers and provide the functionality of service management to the private network without requiring additional mechanism and apparatus. As such, the apparatus may simplify the architecture design and reduce complexity of the deployment of the private network.

According to example embodiments, the apparatus may be further configured to transmit a notification to the UE. The notification may include at least one of: an acknowledgement that the service request has been received, a notification that the service delivery point has been determined, a notification that the information associated with the determined service delivery point and the service has been stored, and the like, along with any related information. For example, the apparatus may transmit a notification to the UE specifying that the service delivery point has been determined, along with information associated with the determined service delivery point.

Upon performing operation S360, the method 300 may be ended or be terminated. Alternatively, method 300 may return to operation S310, such that the at least one processor may be configured to repeatedly perform, for at least a predetermined amount of time, the receiving the service request (at operation S310), the obtaining the information (at operation S320), the determining the service delivery point (at operation S330), the storing the information (at operation S340), the obtaining the service (at operation S350), and the providing the service (at operation S360).

Accordingly, the above processes allow for efficient and effective discovery and management of services without relying on the computational resources of the user equipment and devices in the private network, thereby providing a simple and effective deployment architecture for private networks at various locations.

FIG. 4 illustrates a flow sequence of an example use case for discovery and management of services, according to one or more embodiments. As shown in FIG. 4, the flow sequence may involve a user equipment (UE) 420, a service coordination function (SCF) 440, and a service delivery point (SDP) 460. The UE 420, the SCF 440, and the SDP 460 may be similar to the UE 246, the SCF 244, the ON-MEC 242, the OFF-MECs 222,224, and the hyperscalers 232,234 described above in relation to FIG. 2. Further, one or more operations in FIG. 4 may involve or may be part of one or more operations described above with reference to FIG. 3. For instance, steps 1 to 3 in FIG. 4 may be similar to operations S310 to S340 in FIG. 3, while steps 4 to 6 in FIG. 4 may be part of operation S350 to S360 in FIG. 3.

At step 1, the UE 420 may transmit a service request to the SCF 440, in the similar manner as described above in relation to operation S310 in method 300.

At step 2, the SCF 440 may obtain information associated with the service, determine a service delivery point, and store information associated with the determined service delivery point and the service in the similar manner as described above in relation to operations S320 and S340.

At step 3, the SCF 440 may transmit a notification to the UE 420, where the notification may specify that the service request has been received, that the service delivery point has been determined, and/or that the information associated with the determined service delivery point and the service has been stored.

At step 4 to step 5, the SCF 440 may transmit a request for the service to SDP 460 (i.e., the determined service delivery point), and receive the service from the SDP 460 in the similar manner as described above in relation to operation S350.

In certain implementations, after step 4, the SDP 460 may first transmit a notification acknowledging that the request has been received to the SCF 440, where the SCF 440 may forward such notification to the UE 420. Then the SDP 460 may provide the service to the SCF 440 in step 5.

At step 6, the SCF 440 may provide the service to the UE 420 in the similar manner as described above in relation to operation S360.

### Various Aspects of Embodiments

According to example embodiments, services may be efficiently and effectively discovered and managed without relying on the computational resources of the user equipment and devices in the private network, thereby providing a simple and effective deployment architecture for private networks at various locations

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

One or more components of the apparatus of the example embodiments, as well as the operations associated therewith (e.g., one or more operations in FIG. 3, etc.), may be implemented in one or more systems, devices, or hardware components, such as one or more servers, and the like. In the following, descriptions of a device in which the apparatus or components of the example embodiments may be implemented are provided. It is contemplated that one or more operations or methods described above with reference to FIG. 3 may be performed by the device. For instance, the one or more operations or methods may be performed by at least one processor of the device upon executing machine-readable instructions or computer-readable instructions stored in a memory or a storage component of the device.

FIG. 5 illustrates an embodiment of a device 700 for implementing one or more example embodiments. As shown in FIG. 5, the device 500 includes a processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 causes the processor 510 to perform one or more method steps of an embodiment described herein.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, an instruction device to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of device 500 in communication with one another.

Further, according to example embodiments, the device 500 may include one or more elements from the system architecture described above in relation to FIG. 2. For example, the system 500 may include the SCF 244.

Various further respective aspects and features of embodiments of the present disclosure may be defined by the following items:
Item [1]: An apparatus that may be configured to: receive, from a user equipment within a private network, a service request to receive a service over the private network; obtain information associated with the service; and determine a service delivery point from which the service may be delivered to the user equipment based on the obtained information; wherein the apparatus may be deployed on an on-premise mobile edge cloud (MEC) that is deployed at a same location as the private network.
Item [2]: The apparatus according to item [1], wherein the apparatus may be configured to determine the service delivery point by selecting at least one service delivery point from a plurality of service delivery points based on the obtained information, and wherein the plurality of service delivery points may include the on-premise MEC, a plurality of off-premise MEC associated with an MEC provider, and a plurality of hyperscalers.
Item [3]: The apparatus according to one of items [1]-[2], wherein the apparatus may be further configured to obtain the service from the determined service delivery point and provide the service to the user equipment.
Item [4]: The apparatus according to one of items [1]-[3], wherein the apparatus may be configured to determine at least two service delivery points from which the service may be delivered to the user equipment based on the obtained information, and perform load balancing between the determined at least two service delivery point.
Item [5]: The apparatus according to one of items [1]-[4], wherein the apparatus may be further configured to store information associated with the determined service delivery point and the service.
Item [6]: The apparatus according to one of items [1]-[5], wherein the private network may include a private 5G network.
Item [7]: The apparatus according to one of items [1]-[6], wherein the apparatus may be further configured to transmit a notification to the user equipment, wherein the notification may include at least one of: an acknowledgement that the service request has been received, a notification that the service delivery point has been determined, and a notification that information associated with the determined service delivery point and the service has been stored.
Item [8]: A method that may include: receiving, from a user equipment within a private network, a service request to receive a service over the private network; obtaining information associated with the service; and determining a service delivery point from which the service may be delivered to the user equipment based on the obtained information; wherein the method may be performed by an apparatus that is deployed on an on-premise mobile edge cloud (MEC) that is deployed at a same location as the private network.
Item [9]: The method according to item [8], wherein the determining the service delivery point may include selecting at least one service delivery point from a plurality of service delivery points based on the obtained information, and wherein the plurality of service delivery points may include the on-premise MEC, a plurality of off-premise MEC associated with an MEC provider, and a plurality of hyperscalers.
Item [10]: The method according to one of items [8]-[9], wherein the method may further include obtaining the service from the determined service delivery point and providing the service to the user equipment.
Item [11]: The method according to one of items [8]-[10], wherein the method may include determining at least two service delivery points from which the service may be delivered to the user equipment based on the obtained information, and performing load balancing between the determined at least two service delivery point.
Item [12]: The method according to one of items [8]-[11], wherein the method may further include storing information associated with the determined service delivery point and the service.
Item [13]: The method according to one of items [8]-[12], wherein the private network may include a private 5G network.
Item [14]: The method according to one of items [8]-[13], wherein the method may further include transmitting a notification to the user equipment, wherein the notification may include at least one of: an acknowledgement that the service request has been received, a notification that the service delivery point has been determined, and a notification that information associated with the determined service delivery point and the service has been stored.
Item [15]: A non-transitory computer-readable recording medium that may have recorded thereon instructions executable by an apparatus to cause the apparatus to perform a method including: receiving, from a user equipment within a private network, a service request to receive a service over the private network; obtaining information associated with the service; and determining a service delivery point from which the service may be delivered to the user equipment based on the obtained information; wherein the apparatus may be deployed on an on-premise mobile edge cloud (MEC) that is deployed at a same location as the private network.
Item [16]: The non-transitory computer-readable recording medium according to item [15], wherein the determining the service delivery point may include selecting at least one service delivery point from a plurality of service delivery points based on the obtained information, and wherein the plurality of service delivery points may include the on-premise MEC, a plurality of off-premise MEC associated with an MEC provider, and a plurality of hyperscalers.
Item [17]: The non-transitory computer-readable recording medium according to one of items [15]-[16], wherein the method may further include obtaining the service from the determined service delivery point and providing the service to the user equipment.
Item [18]: The non-transitory computer-readable recording medium according to one of items [15]-[17], wherein the method may include determining at least two service delivery points from which the service may be delivered to the user equipment based on the obtained information, and performing load balancing between the determined at least two service delivery point.
Item [19]: The non-transitory computer-readable recording medium according to one of items [15]-[18], wherein the method may further include storing information associated with the determined service delivery point and the service.
Item [20]: The non-transitory computer-readable recording medium according to one of items [15]-[19], wherein the private network may include a private 5G network.

It is understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus configured to:
receive, from a user equipment within a private network, a service request to receive a service over the private network;
obtain information associated with the service; and
determine a service delivery point from which the service is delivered to the user equipment based on the obtained information,
wherein the apparatus is deployed on an on-premise mobile edge cloud (MEC) that is deployed at a same location as the private network.

2. The apparatus according to claim 1, wherein the apparatus is configured to determine the service delivery point by selecting at least one service delivery point from a plurality of service delivery points based on the obtained information, and wherein the plurality of service delivery points comprises the on-premise MEC, a plurality of off-premise MEC associated with an MEC provider, and a plurality of hyperscalers.

3. The apparatus according to claim 1, wherein the apparatus is further configured to obtain the service from the determined service delivery point and provide the service to the user equipment.

4. The apparatus according to claim 1, wherein the apparatus is configured to determine at least two service delivery points from which the service is delivered to the user equipment based on the obtained information, and perform load balancing between the determined at least two service delivery point.

5. The apparatus according to claim 1, wherein the apparatus is further configured to store information associated with the determined service delivery point and the service.

6. The apparatus according to claim 1, wherein the private network comprises a private 5G network.

7. The apparatus according to claim 1, wherein the apparatus is further configured to transmit a notification to the user equipment, wherein the notification comprises at least one of: an acknowledgement that the service request has been received, a notification that the service delivery point has been determined, and a notification that information associated with the determined service delivery point and the service has been stored.

8. A method comprising:
receiving, from a user equipment within a private network, a service request to receive a service over the private network;
obtaining information associated with the service; and
determining a service delivery point from which the service is delivered to the user equipment based on the obtained information;
wherein the method is performed by an apparatus that is deployed on an on-premise mobile edge cloud (MEC) that is deployed at a same location as the private network.

9. The method according to claim 8, wherein the determining the service delivery point comprises selecting at least one service delivery point from a plurality of service delivery points based on the obtained information, and wherein the plurality of service delivery points comprises the on-premise MEC, a plurality of off-premise MEC associated with an MEC provider, and a plurality of hyperscalers.

10. The method according to claim 8, wherein the method further comprises obtaining the service from the determined service delivery point and providing the service to the user equipment.

11. The method according to claim 8, wherein the method comprises determining at least two service delivery points from which the service is delivered to the user equipment based on the obtained information, and performing load balancing between the determined at least two service delivery point.

12. The method according to claim 8, wherein the method further comprises storing information associated with the determined service delivery point and the service.

13. The method according to claim 8, wherein the private network comprises a private 5G network.

14. The method according to claim 8, wherein the method further comprises transmitting a notification to the user equipment, wherein the notification comprises at least one of: an acknowledgement that the service request has been received, a notification that the service delivery point has been determined, and a notification that information associated with the determined service delivery point and the service has been stored.

15. A non-transitory computer-readable recording medium having recorded thereon
instructions executable by an apparatus to cause the apparatus to perform a method comprising:
receiving, from a user equipment within a private network, a service request to receive a service over the private network;
obtaining information associated with the service; and
determining a service delivery point from which the service is delivered to the user equipment based on the obtained information;
wherein the apparatus is deployed on an on-premise mobile edge cloud (MEC) that is deployed at a same location as the private network.

16. The non-transitory computer-readable recording medium according to claim 15, wherein the determining the service delivery point comprises selecting at least one service delivery point from a plurality of service delivery points based on the obtained information, and wherein the plurality of service delivery points comprises the on-premise MEC, a plurality of off-premise MEC associated with an MEC provider, and a plurality of hyperscalers.

17. The non-transitory computer-readable recording medium according to claim 15, wherein the method further comprises obtaining the service from the determined service delivery point and providing the service to the user equipment.

18. The non-transitory computer-readable recording medium according to claim 15, wherein the method comprises determining at least two service delivery points from which the service is delivered to the user equipment based on the obtained information, and performing load balancing between the determined at least two service delivery point.

19. The non-transitory computer-readable recording medium according to claim 15, wherein the method further comprises storing information associated with the determined service delivery point and the service.

20. The non-transitory computer-readable recording medium according to claim 15, wherein the private network comprises a private 5G network.
